(19) United States
(12) Patent Application Publication
(10) Pub. No.: US 2017/0359741 A1
(43) Pub. Date: Dec. 14, 2017

(54) DATA PROCESSING APPARATUS, DATA PROCESSING METHOD AND NON-TRANSITORY COMPUTER READABLE MEDIUM

(71) Applicant: KABUSHIKI KAISHA TOSHIBA, Minato-ku (JP)

(72) Inventors: Yusuke DOI, Kawasaki (JP); Yuki YONEZAWA, Ayase (JP)

(73) Assignee: KABUSHIKI KAISHA TOSHIBA, Minato-ku (JP)

(21) Appl. No.: 15/445,515

(22) Filed: Feb. 28, 2017

(30) Foreign Application Priority Data
Jun. 8, 2016 (JP) 2016-114368

(51) Int. Cl. H04W 24/08; H04W 4/02

(52) U.S. Cl. CPC H04W 24/08; H04W 4/021

(57) ABSTRACT

A data processing apparatus in accordance with the embodiment of the present invention includes a reception power data storage, reference data storage, and a processor. The reception power data storage stores reception power data that contains a plurality of reception power values of a radio signal, which is transmitted from the wireless communication apparatus, obtained by a plurality of measurement apparatuses. The reference data storage stores reference data which is used to determine the state of the wireless communication apparatus. The processor determines the state of the wireless communication apparatus, which has transmitted the radio signal, on the basis of the reception power data and reference data.

### CROSS-REFERENCE TO RELATED APPLICATION (S)

This application is based upon and claims the benefit of priority from Japanese Patent Application No. 2016-114368, filed Jun. 8, 2016; the entire contents of which are incorporated herein by reference.

### FIELD

Embodiments described herein relate generally to a data processing apparatus, a data processing method and a non-transitory computer readable medium.

### BACKGROUND

By replacing a wired communication apparatus with a wireless communication apparatus, it has become possible to freely move the wireless communication apparatus, and convenience has improved. In contrast, a risk that the wireless communication apparatus may be lost because it is, for example, erroneously taken away has risen. This necessitates a system that administers the wireless communication apparatus.

As one of methods for administering a wireless communication apparatus, there is a method of estimating the distance between wireless communication apparatuses on the basis of radio waves. However, the intensity of a radio wave readily varies depending on the orientation of the wireless communication apparatus or the ambient situation. Therefore, as far as a compact wireless communication apparatus which a user can hold and move with his/her hand is concerned, although the orientation of the wireless communication apparatus or the ambient situation has changed, the distance between wireless communication apparatuses is often erroneously detected to have changed.

### BRIEF DESCRIPTION OF THE DRAWINGS

FIG. 1 is a block diagram illustrating an example of an outline configuration of an administration system in accordance with a first embodiment;

FIG. 2 is an example of a flowchart illustrating overview processing in the administration system in accordance with the first embodiment;

FIG. 3 is a block diagram illustrating an example of an outline configuration of a data processing apparatus in accordance with the first embodiment;

FIG. 4 is a diagram illustrating an example of reception power data;

FIG. 5 is a diagram illustrating a result of determination;

FIG. 6 is a diagram explaining an outlier;

FIG. 7 is an example of a flowchart illustrating overview processing in the data processing apparatus in accordance with the first embodiment;

FIG. 8 is a block diagram illustrating a variant of the outline configuration of the data processing apparatus in accordance with the first embodiment;

FIG. 9 is a block diagram illustrating an example of an outline configuration of a data processing apparatus in accordance with a second embodiment;

FIG. 10 is an example of a flowchart illustrating feedback processing in the data processing apparatus in accordance with the second embodiment; and

FIG. 11 is a block diagram illustrating an example of a hardware configuration in accordance with an embodiment of the present invention.

### DETAILED DESCRIPTION

An embodiment of the present invention determines the state of a wireless communication apparatus on the basis of reception powers of a radio signal, which is sent from the wireless communication apparatus, measured by a plurality of measurement apparatuses.

A data processing apparatus in accordance with the embodiment of the present invention includes a reception power data storage, reference data storage, and a processor. The reception power data storage stores reception power data that contains a plurality of reception power values of a radio signal, which is transmitted from the wireless communication apparatus, obtained by a plurality of measurement apparatuses. The reference data storage stores reference data which is used to determine the state of the wireless communication apparatus. The processor determines the state of the wireless communication apparatus, which has transmitted the radio signal, on the basis of the reception power data and reference data.

Below, a description is given of embodiments of the present invention with reference to the drawings. The present invention is not limited to the embodiments.

### First Embodiment

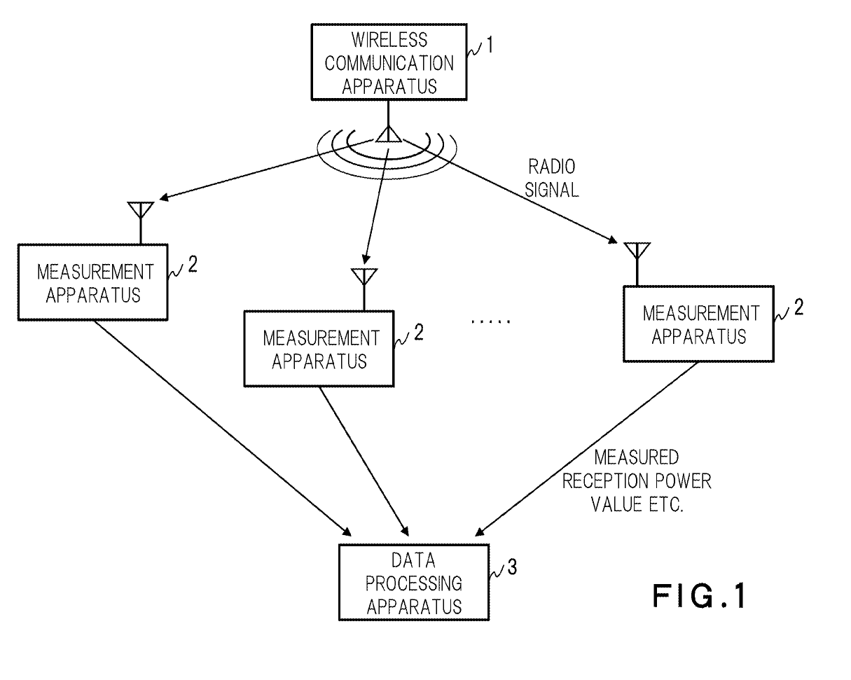

FIG. 1 is a block diagram illustrating an example of an outline configuration of an administration system in accordance with a first embodiment. The administration system in accordance with the first embodiment includes a wireless communication apparatus 1, measurement apparatuses 2, and a data processing apparatus 3. In the system, at least two measurement apparatuses are present. Further, the administration system may accommodate a plurality of wireless communication apparatuses 1 and a plurality of data processing apparatuses 3.

In the administration system in accordance with the first embodiment, the wireless communication apparatus 1 transmits a radio signal, and each of the measurement apparatuses 2 measures the reception power of the radio signal. The term “reception power” shall encompass a receiving signal strength indicator (RSSI). The measurement apparatus 2 transmits the measured reception power value to the data processing apparatus 3. The data processing apparatus 3 determines the state of the wireless communication apparatus 1 on the basis of the reception power values of at least two measurement apparatuses 2. Note that communications between each of the measurement apparatuses 2 and the data processing apparatus 3 may be performed via an apparatus or a network that are not illustrated. The communications may be performed wirelessly or by wire.

The state of the wireless communication apparatus 1 may be whatever is correlated with the reception power of a radio signal. Herein, the state of the wireless communication apparatus 1 shall signify a range within which the wireless communication apparatus 1 exists. For example, a state that is normal signifies that the wireless communication apparatus 1 exists within a predetermined range, while a state that is abnormal signifies that the wireless communication apparatus exists outside the predetermined range, or in other words, that the wireless communication apparatus does not exist within the predetermined range. The data processing apparatus 3 determines based on the reception power whether the state is normal or abnormal. In addition, any other state that is neither normal nor abnormal may be included. For example, a normal state may signify that the wireless communication apparatus 1 exists within a first range, a permissible state may signify that the wireless communication apparatus 1 exists within a second range, an alert state may signify that the wireless communication apparatus 1 exists within a third range, and an abnormal state may signify that the wireless communication apparatus 1 exists within a fourth range. By finely classifying states, processing to be associated with a determined state can be finely defined. Thus, the data processing apparatus 3 selects the state of the wireless communication apparatus 1 from among a plurality of predefined state candidates (labels).

As one of concrete examples of the administration system in accordance with the first embodiment, a point-of-sales (POS) system is conceivable. A handy terminal which a salesperson uses is conceived as the wireless communication apparatus 1, and a POS terminal that is installed in a shop is conceived as the measurement apparatus 2. The handy terminal transmits data such as inventory management, order processing, article bar codes, or credit-card settlements using a predetermined radio frequency band. The POS terminal has a user interface which a salesperson manipulates, and receives or disburses cash at the same time when acknowledging or verifying a transaction entered at the POS terminal. The POS terminal is connected onto a LAN constructed wirelessly or by wire in a shop, and communicates with the data processing apparatus 3. The plurality of measurement apparatuses 2 may not be of the same type. For example, one of the measurement apparatuses 2 may be the POS terminal, and the other measurement apparatus may be an apparatus other than the POS terminal.

The present embodiment employs at least two measurement apparatuses 2. The reception power of a radio signal sent from the wireless communication apparatus 1 gets smaller as the distance of the wireless communication apparatus 1 from the measurement apparatus 2 gets larger. Further, the reception power varies depending on the orientation of the wireless communication apparatus 1. Therefore, even when the distance from the wireless communication apparatus 1 remains unchanged, the reception power to be measured may be different. Therefore, when the number of measurement apparatuses 2 is one, even if the measured reception power is smaller than the previously measured one, the distance of the wireless communication apparatus 1 from the measurement apparatus 2 cannot be asserted to have gotten larger. In order to make it possible to discriminate a change in the orientation or position of the wireless communication apparatus 1, the plurality of measurement apparatuses 2 are employed as they are in the present embodiment.

A configuration in which each of the plurality of measurement apparatuses 2 originates a radio signal and one wireless communication apparatus 1 measures the reception powers of the respective radio signals is conceivable. However, in the configuration, there is a high possibility that the measured reception powers may not correlate with each other. This is because there is a possibility that before the wireless communication apparatus 1 receives the radio signals, if the wireless communication apparatus 1 is operated by a user or the like, the orientation or position of the wireless communication apparatus 1 may change and the reception powers may largely change. Therefore, similarly in the present embodiment, the plurality of measurement apparatuses 2 measure the reception power of a radio signal originated from the one wireless communication apparatus 1.

Accordingly, the reception powers measured by the respective measurement apparatuses 2 correlate with each other. It should be noted that the measurement apparatuses 2 are assumed not to be moved during measurement.

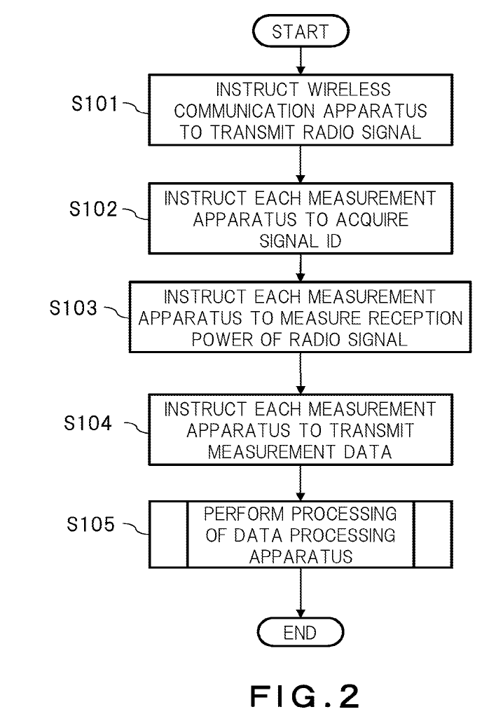

For the details of the apparatuses, a description will be made in conjunction with processing flows. FIG. 2 is an example of a flowchart illustrating overview processing in the administration system in accordance with the first embodiment.

The wireless communication apparatus 1 transmits a radio signal (S101). The radio signal shall contain identification information (signal ID) with which the radio signal is identified. The signal ID may be, for example, a sequence number assigned sequentially to the radio signal. Owing to the signal ID, measured reception powers can be classified for each radio signal.

In a case where the plurality of wireless communication apparatuses 1 are present in the administration system, a radio signal shall contain identification information (wireless communication apparatus ID) with which the wireless communication apparatus 1 is identified. The wireless communication apparatus ID shall differ from one wireless communication apparatus 1 to another. Accordingly, measured reception power values can be classified for each wireless communication apparatus 1.

A radio signal shall be regularly transmitted. If the wireless communication apparatus 1 regularly transmits a beacon signal, a signal ID may be contained in the beacon signal. Further, the radio signal may be transmitted according to the timing of a specific event. For example, when the wireless communication apparatus 1 receives a predetermined signal or when the wireless communication apparatus 1 is decided to have been moved by a user, the radio signal may be transmitted. Whether the wireless communication apparatus 1 has been moved can be decided by attaching an acceleration sensor to the wireless communication apparatus 1.

Each of the measurement apparatuses 2 receives a radio signal sent from the wireless communication apparatus 1, and acquires a signal ID (S102). In addition, each of the measurement apparatuses 2 measures the reception power of the radio signal (S103).

Each of the measurement apparatuses 2 transmits measurement data to the data processing apparatus 3 (S104). The measurement data represents a combination (tuple) associated with at least a measured reception power of the radio signal, a signal ID of the radio signal, and identification information (measurement apparatus ID) on the measurement apparatus 2 which has measured the reception power value.

In a case where the plurality of wireless communication apparatuses 1 exist in the administration system, a wireless communication apparatus ID shall be incorporated in measurement data.

The timing of transmitting measurement data is not limited to any specific one. A plurality of measurement data blocks may be regularly transmitted altogether at a predetermined time or at regular intervals. Otherwise, every time a reception power is measured, the measurement data may be transmitted.

After each of the measurement apparatuses transmits measurement data, processing of the data processing apparatus 3 is performed (S105). This processing flow terminates.

The data processing apparatus 3 will be described below. The data processing apparatus 3 determines the state of the wireless communication apparatus 1 on the basis of the plurality of measurement data blocks and reference data that is preliminarily calculated.

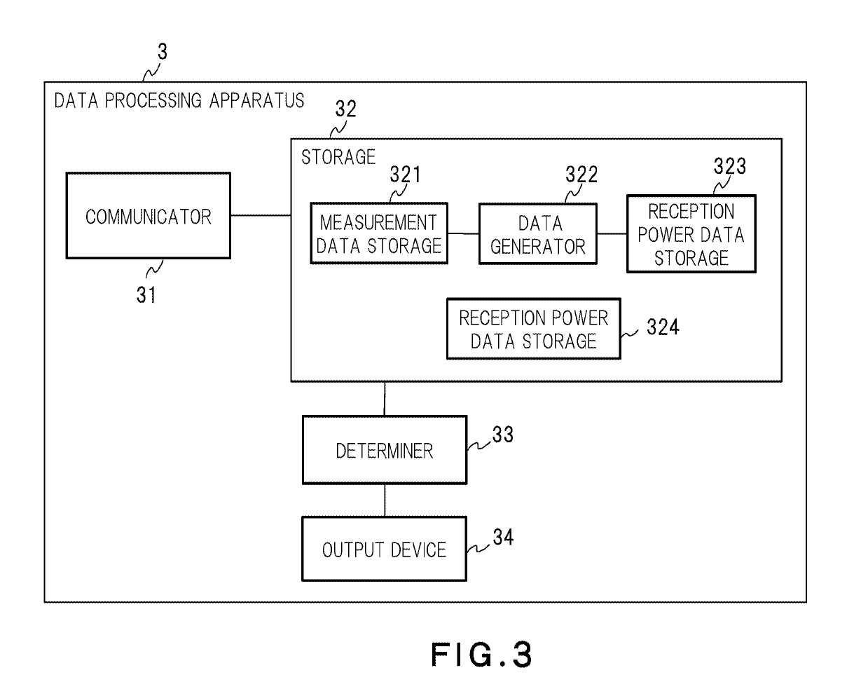

FIG. 3 is a block diagram illustrating an example of an outline configuration of the data processing apparatus 3 in accordance with the first embodiment. The data processing apparatus 3 includes a communicator 31, storage 32, determiner 33, and output device 34. The storage 32 includes a measurement data storage 321, data generator 322, reception power data storage 323, and reference data storage 324.

The communicator 31 receives measurement data from each of the measurement apparatuses 2. The received measurement data is stored in the storage 32.

The storage 32 stores data that are employed in processing of the data processing apparatus 3. The measurement data storage 321 in the storage 32 stores measurement data. The data generator 322 generates reception power data from the measurement data. The reception power data storage 323 stores the reception power data. The reference data storage 324 stores reference data.

Note that, since the data generator 322 can be implemented using a feature of management software for a relational database or the like which implements the storage 32, the data generator 322 is drawn within the storage 32. Alternatively, the data generator 322 may, similarly to the determiner 33, exist outside the storage 32. In FIG. 3, the one storage 32 includes the measurement data storage 321, reception power data storage 323, and reference data storage 324. Alternatively, the data processing apparatus 3 may include a plurality of storages 32, and the measurement data storage 321, reception power data storage 323, and reference data storage 324 may exist within the different storages 32.

The data generator 322 detects measurement data blocks, which are associated with the same signal ID, from among a plurality of measurement data blocks stored in the measurement data storage 321. Then, the data generator 322 generates a set that has the reception power values of the detected measurement data blocks as constituent elements. The set is referred to as reception power data. The order (arrangement) of constituent elements of reception power data shall be predefined.

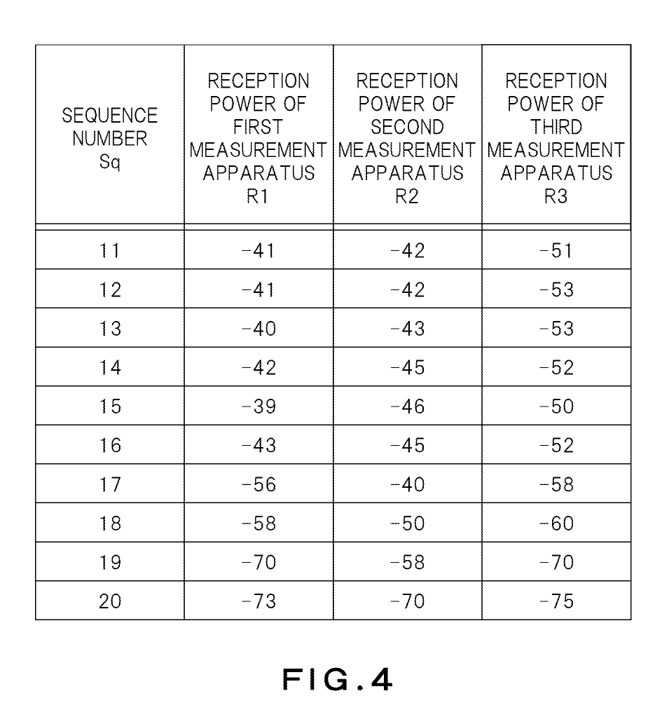

FIG. 4 is a diagram illustrating an example of reception power data. In the example of FIG. 4, three measurement apparatuses 2 of the first to third measurement apparatuses shall be included. The first column of the table illustrated in FIG. 4 indicates a sequence number (Sq) contained in a radio signal as a signal ID. The second to fourth columns indicate reception powers of a radio signal measured by the three respective measurement apparatuses 2. The data in the second to fourth columns on each row constitute reception power data. For example, in FIG. 4, the reception power data of sequence number 11 is (−41, −42, −51). The reception power data of sequence number 20 is (−73, −70, −75).

The reference data storage 324 stores reference data which the determiner 33 uses to determine the state of the wireless communication apparatus 1. The reference data shall be preliminarily calculated and stored in the reference data storage 324. The reference data varies depending on a determination method of the determiner 33. A description will be made later.

The determiner 33 extracts reception power data, which is employed in determination, from the reception power data storage 323. The determiner 33 determines the state of the wireless communication apparatus 1 on the basis of the extracted reception power data of the reception power data storage 323 and the reference data of the reference data storage 324. More particularly, an appropriate state is selected from among the predefined state candidates including normal and abnormal states. A result of determination may be calculated together with a numerical value representing a degree of certainty.

The timing of determination is not limited to any specific one. Determination may be regularly performed every after the elapse of a certain period of time. Alternatively, determination may be irregularly performed by regarding, for example, update of the reception power data storage 323 as a trigger.

A method employed in determination may be freely determined as appropriate. For example, determination is conceivably performed based on coordinates of reception power data projected onto a two or larger-dimensional space (multidimensional space). In the case of FIG. 4, since the number of measurement apparatuses 2 is three, reception power data is projected onto a three-dimensional space. A point corresponding to sequence number 11 is projected to coordinates (−41, −42, −51). A point corresponding to sequence number 20 is projected to coordinates (−73, −70, −75). Examples of a determination method based on coordinates of reception power data thus projected onto the multidimensional space will be described below.

### (Determination Method 1)

If determination is performed through binary classification, a hyperplane calculated according to a support vector machine based on a kernel method is used to perform determination. The support vector machine based on the kernel method calculates a hyperplane with which a plurality of data blocks, which are projected onto a multidimensional space, are separated into an area, in which positive-example (normal) data alone exist, and an area in which negative-example (abnormal) data alone exist. The pre-calculated hyperplane is stored as reference data in the reference data storage 324. Based on the hyperplane, the determiner 33 checks coordinates of reception power data, which is projected onto the multidimensional space, to see to which of the areas that are separated with the hyperplane the coordinates belong. If the multidimensional space is two-dimensional, the hyperplane is expressed with a straight line.

Note that positive-example data and negative-example data employed in calculation of a hyperplane may be reception power data which are actually measured or tentative data (dummy data). The degree of certainty of determination may be calculated based on the number of data blocks employed in calculation of the hyperplane, the distance of coordinates from the hyperplane or the like. Note that the multidimensional space is expressed with reception power values (including reception signal strength values) of the respective measurement apparatuses.

### (Determination Method 2)

A k-nearest neighbor algorithm may be used to perform determination. If the k-nearest neighbor algorithm is used, the reception power data and a plurality of data blocks related to the reception power data are stored as reference data, the plurality of data blocks being associated with the state of the wireless communication apparatus 1 which is related to the reception power data. The reception power data may be actually measured data or dummy data. The determiner 33 extracts k (an integer equal to or larger than 2) data blocks from the reference data in the order in which the distance from the reception power data for determination in a multidimensional space is nearer. Among states relating to all the extracted data blocks, the largest number of states is determined as the state of the wireless communication apparatus 1. The occupancy of the data blocks relating to the largest number of states to all the extracted data blocks may be regarded as a degree of certainty of determination.

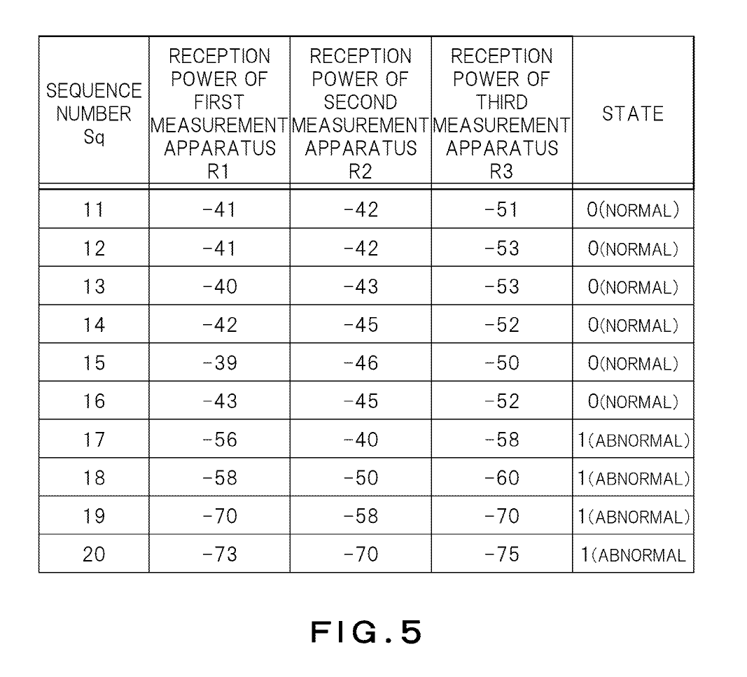

FIG. 5 is a diagram illustrating results of determinations. Data listed in FIG. 5 may serve as data to be employed in calculation of a hyperplane in a case where a support vector machine is used or reference data in a case where a k-nearest neighbor algorithm is used. As for states indicated on the rightmost column, 0 signifies a normal state, and 1 signifies an abnormal state. In the case of the k-nearest neighbor algorithm, the states indicated on the rightmost column may not only be classified into the normal and abnormal states but also include a plurality of other categories.

FIG. 5 is based on the assumption that determination is performed one by one on reception power data blocks. Alternatively, determination may be performed based on a plurality of reception power data blocks. For example, after a mean value, minimum value, and maximum value are obtained from the plurality of reception power data blocks, determination may be performed based on these values.

The determiner 33 may abstract reception power data. Abstraction makes it possible to remove an outlier stemming from fading or the like and thus upgrade precision in determination.

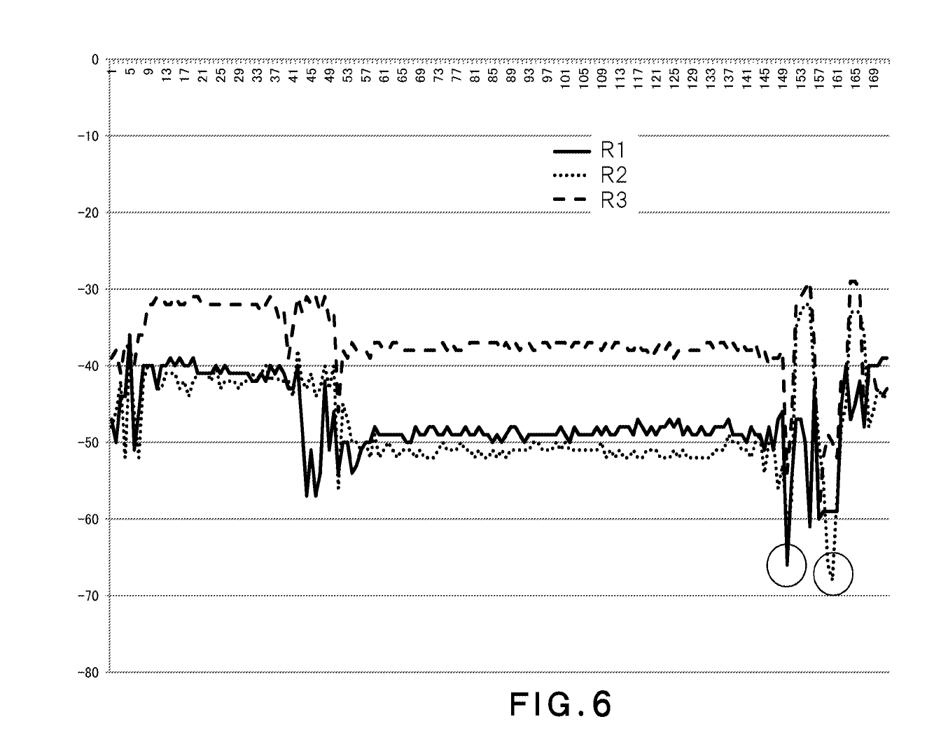

FIG. 6 is a diagram for explaining an outlier. When an order of a radio signal is known, for example, when the signal ID of the radio signal is a sequence number, a time-sequential graph of reception powers can be, as illustrated in FIG. 6, created by sorting the reception power values in ascending order of the radio signal. Some outliers are shown while being encircled. If an outlier is present, there is a high possibility that erroneous determination may be brought about. Therefore, the outlier may be abstracted in consideration of one or a plurality of surrounding reception power values, whereby erroneous determination may be prevented.

For abstraction, for example, a method employing a moving average is conceivable. The moving average includes known moving averages such as a simple moving average, weighted moving average, and index moving average. For example, when it comes to the index moving average, an average value q, which is updated with a latest measured value s after measurement, is expressed as q=α·p+(1−α)·s where p denotes an average value before measurement and α denotes a smoothing coefficient that is a constant equal to or larger than 0 and equal to or smaller than 1. By employing the equation, and coordinates in a multidimensional space which are based on the average value q updated at every time of measurement, a tentatively abnormal value can be excluded and a continuous abnormal value can be detected.

Depending on a context (state, situation, condition, or the like) in which the wireless communication apparatus 1 is used, a state that should be determined to be abnormal may vary. For example, in a case where the wireless communication apparatus 1 exists in a shop, the state that should be determined to be abnormal may vary depending on whether the shop has not yet opened, is in business, or has closed. When the shop is in business, the wireless communication apparatus 1 is frequently moved because it is used. When the shop has not yet opened or has closed, the wireless communication apparatus 1 is thought to be hardly moved. Therefore, information on a time point, a day of week, or singular days including holidays of the year-end, New Year and nation may be added as one dimension of a multidimensional space. Instead of the time point, a state in which preparations are being made prior to opening, the shop is in business, the mess is being cleaned up after closing, or the shop has closed may be added as one dimension.

The output device 34 outputs a result of determination acquired from the determiner 33. The result of determination may be outputted every time determination is performed. Otherwise, a plurality of results of determinations may be outputted altogether. When a predetermined condition is met, the output device 34 may provide an output. For example, the output device 34 may provide an output in a case where a result of determination is a vigilant state, abnormal state, or any other state that should be reported to an administrator. For example, once a case where the wireless communication apparatus 1 is displaced too far from a predetermined position is designated as the vigilant state or abnormal state, a possibility that the wireless communication apparatus 1 may be lost can be diminished.

For example, when a result of previous determination is a normal state, even if a result of current determination is an abnormal state, an output may not be provided. Otherwise, if a result of determination is the abnormal state a predetermined number of successive times beginning with this time, the result of determination may be outputted. This prevents an incident that user's work is interrupted due to erroneous detection.

An output method and output destination are not limited to any specific ones, but may be defined based on an apparatus connected to the data processing apparatus 3. For example, when a display is connected to the data processing apparatus 3, a result of determination is image data or text data to be displayed on the display. When a loudspeaker is connected to the data processing apparatus, the result of determination is audio data such as a music or buzz. When lighting equipment such as an LED or warning light is connected to the data processing apparatus 3, the result of determination may be a lighting control signal that controls lighting, extinguishing, or flickering of the lighting equipment. Further, a file output command or the like may be executed in order to output a file, which specifies the result of determination, to the storage 32 of the data processing apparatus 3. A radio signal or broadcasting signal may be used to transmit a file, mail, or the like to an external apparatus.

A plurality of apparatuses may be connected to the data processing apparatus 3, and an output destination may be selected according to settings, a result of determination, or a degree of certainty of determination. For example, if a result of determination is a normal state, the result is outputted to a file. If the result of determination is an abnormal state, a warning light may be turned on.

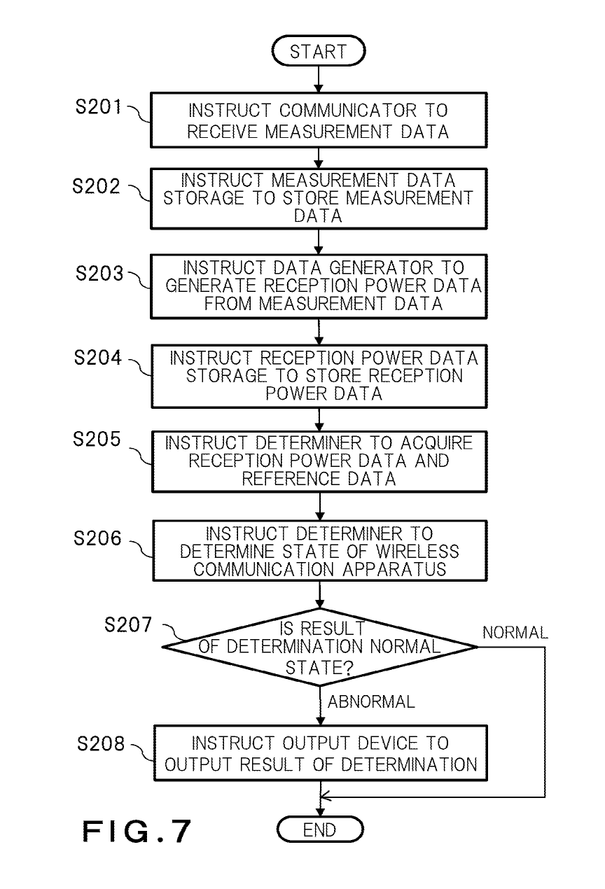

FIG. 7 is an example of a flowchart illustrating overview processing in the data processing apparatus 3 in accordance with the first embodiment. Note that reference data is preliminarily stored in the reference data storage 324.

The communicator 31 receives measurement data from the respective measurement apparatuses 2 (S201). The measurement data are sent to the storage 32, and stored in the measurement data storage 321 of the storage 32 (S202).

The data generator 322 generates reception power data from measurement data, which are stored in the measurement data storage 321, using a signal ID as a key (S203). At this time, each value of reception powers contained in the reception power data may be abstracted using a moving average. The reception power data storage 323 stores the generated reception power data (S204).

The determiner 33 acquires reception power data from the reception power data storage 323 and also acquires reference data from the reference data storage 324 (S205). S205 may be performed immediately subsequently to S204 or may be performed at a predetermined time. The determiner 33 determines the state of the wireless communication apparatus 1 on the basis of the reception power data and reference data (S206).

If a result of determination is a normal state (normal state at S207), the processing flow terminates. If the result of determination is an abnormal state or the like which has to be reported to a user (abnormal state at S207), the output device 34 outputs the result of determination (S208) and the processing flow terminates.

The flowchart is a mere example. The present invention is not limited to the processing flow described in the flowchart. For example, in the flowchart, in the case of an abnormal state, branching at S207 leads to outputting of a result of determination. Alternatively, every result of determination may be outputted irrespective of whatever the result is.

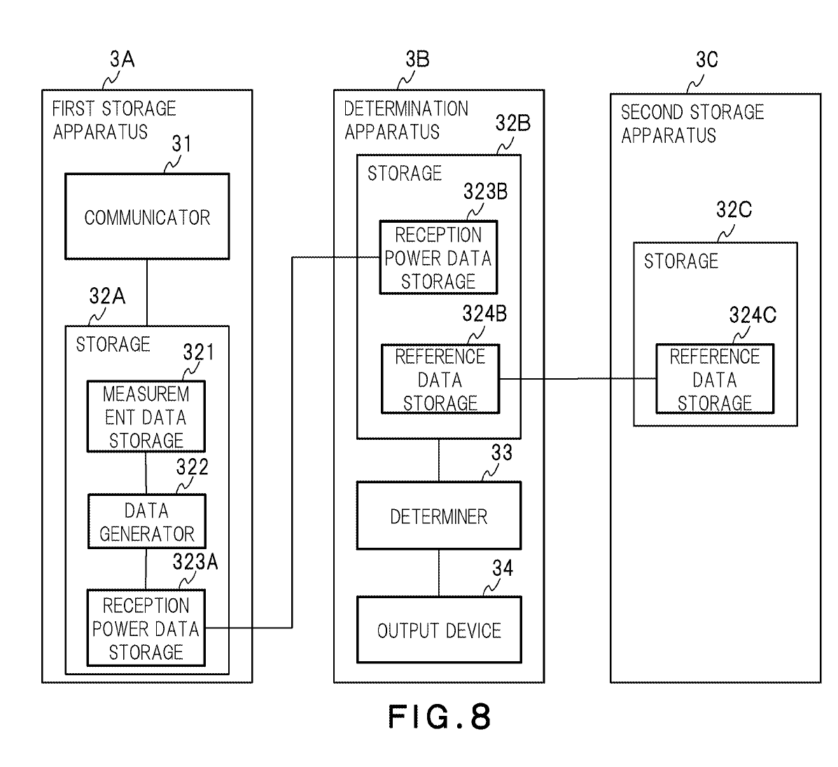

The data processing apparatus 3 may include a plurality of apparatuses that can transfer data to or from one another through communications or by means of an electric signal. FIG. 8 is a block diagram illustrating a variant of the outline configuration of the data processing apparatus 3 in accordance with the first embodiment. In FIG. 8, the data processing apparatus 3 (data processing system) includes three apparatuses of a first storage apparatus 3A, determination apparatus 3B, and second storage apparatus 3C.

The first storage apparatus 3A includes a communicator 31 and storage 32A. The storage 32A includes a measurement data storage 321, data generator 322, and reception power data storage 323A. The first storage apparatus 3A performs processing of producing reception power data from measurement data acquired from the plurality of measurement apparatuses 2, and then storing the reception power data.

The second storage apparatus 3C includes a storage 32C including a reference data storage 324C, and stores reference data.

The determination apparatus 3B includes a storage 32B, determiner 33, and output device 34. The storage 32B includes a reception power data storage 323B that stores reception power data acquired from the first storage apparatus 3A, and a reference data storage 324B that stores reference data acquired from the second storage apparatus 3C. The determination apparatus 3B performs determination on the basis of the acquired reception power data and reference data, and outputs a result of determination. Thus, the processing of the data processing apparatus 3 may be dispersed to a plurality of stand-alone apparatuses.

As mentioned above, according to the first embodiment, the data processing apparatus 3 determines the state of the wireless communication apparatus 1, which has transmitted a radio signal, on the basis of reception power data and reference data. Accordingly, a state in which, for example, the wireless communication apparatus 1 does not exist within a predetermined range is revealed, and an incident that the wireless communication apparatus 1 is taken away can be prevented.

### Second Embodiment

In the present embodiment, reference data stored in the reference data storage 324 is updated based on a result of determination for the purpose of upgrading precision in determination.

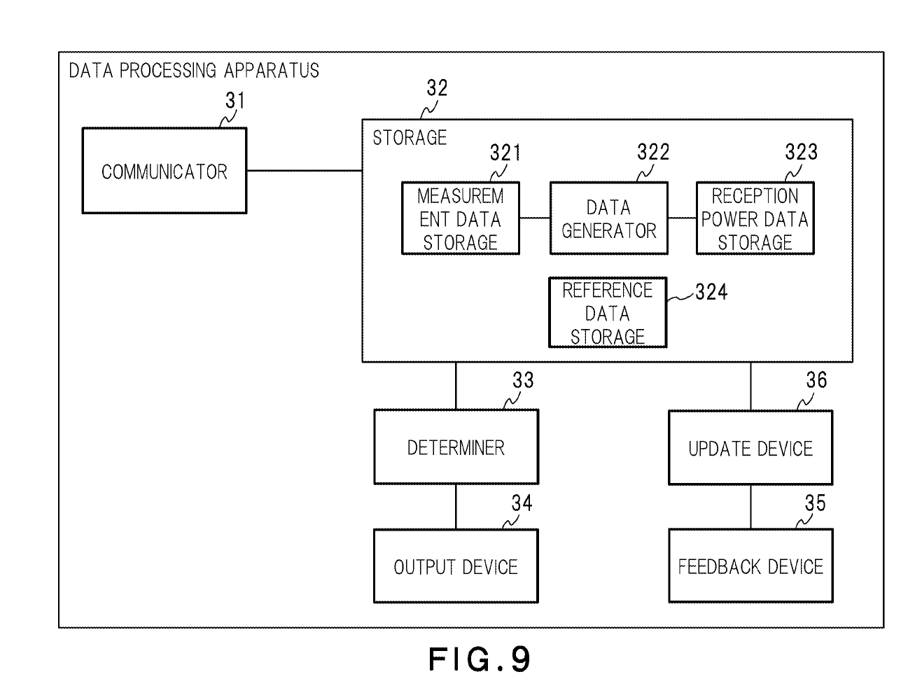

FIG. 9 is a block diagram illustrating an example of an outline configuration of a data processing apparatus in accordance with the second embodiment. In the second embodiment, the data processing apparatus 3 further includes a feedback device 35 and update device 36. As for a point identical to that in the first embodiment, a description will be omitted.

The feedback device 35 acquires the state of the wireless communication apparatus 1 which is associated with reception power data. An inputting method is not limited to any specific one, and may be determined as appropriate based on an apparatus to be connected.

For example, the output device 34 displays a dialog box, which is used to check a current state, together with a result of determination on a display device. Then, a user who has looked at the display enters the state of the wireless communication apparatus 1. Accordingly, whether the result of determination is right or wrong can be fed back. Reception power data relating to the entered state of the wireless communication apparatus 1 may be newly entered together with the state of the wireless communication apparatus 1, or may be acquired from the output device 34 or determiner 33.

Further, for example, the feedback device 35 may acquire a file, in which reception power data and the actual state of the wireless communication apparatus 1 are recorded, from the storage 32 or an external apparatus.

If data (null) signifying that updating is not performed is entered instead of a current state, the feedback device 35 may not perform feedback.

The update device 36 updates reference data in the reference data storage 324 on the basis of data sent from the feedback device. Accordingly, performance in determination can be upgraded.

For example, if a determination method is a k-nearest neighbor algorithm, data as shown in FIG. 5 is added to the reference data storage 32, the data being associated with the reception power data and the state of the wireless communication apparatus 1 which relates to the reception power data. For example, if the determination method is a support vector machine, a hyperplane is newly calculated based on the data that has, as shown in FIG. 5, the reception power data and the state of the wireless communication apparatus 1, which relates to the reception power data, associated with each other. The calculated hyperplane is used to update the reference data in the reference data storage 32.

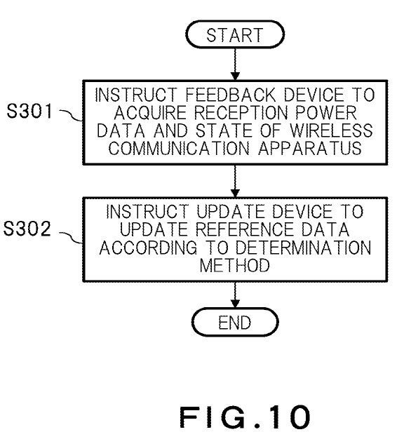

FIG. 10 is an example of a flowchart illustrating feedback processing in the data processing apparatus 3 in accordance with the second embodiment. The processing flow is initiated when data relating to feedback is entered by a user or inputted from other system.

The feedback device 35 acquires reception power data and the state of the wireless communication apparatus 1 on the basis of the entered data (S301). The update device 36 updates reference data according to a predetermined determination method (S302). The processing flow then terminates.

As described so far, according to the second embodiment, a result of determination is fed back. Accordingly, reference data is updated, and performance in determination can be upgraded.

Each process in the embodiments described above can be implemented by software (program). Thus, the embodiments described above can be implemented using, for example, a general-purpose computer apparatus as basic hardware and causing a processor mounted in the computer apparatus to execute the program.

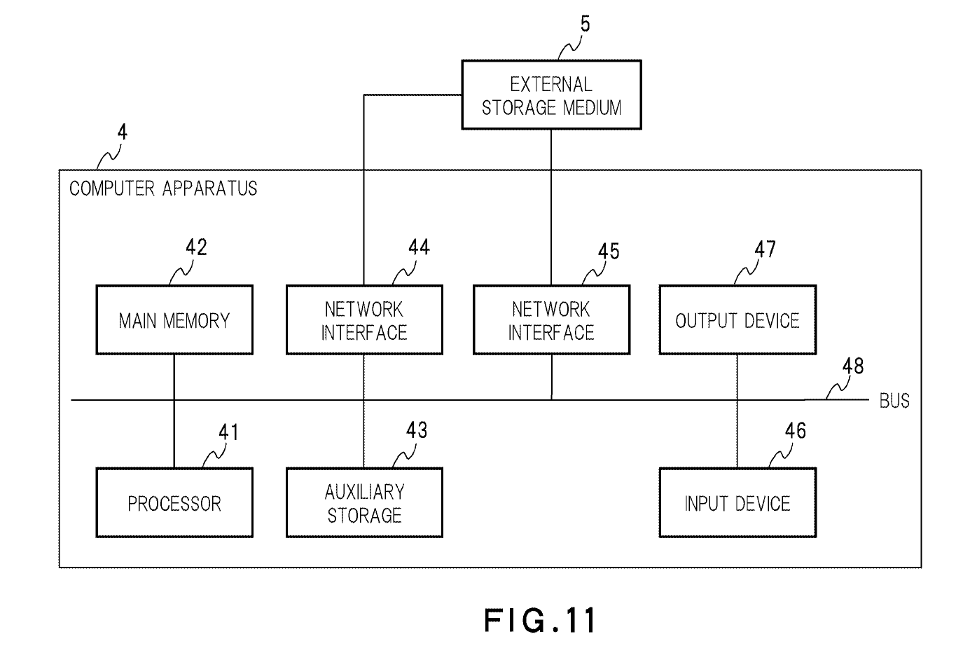

FIG. 11 is a block diagram illustrating an example of a hardware configuration in an embodiment of the present invention. The data processing apparatus 3 includes a processor 41, main memory 42, auxiliary storage 43, network interface 44, device interface 45, input device 46, and output device 47, and can be realized as a computer apparatus 4 having these components interconnected over a bus 48. Note that each component of the hardware may be provided one each as illustrated in FIG. 16 or a plurality of components may be provided.

The data processing apparatus 3 in the present embodiment may be realized by preliminarily installing programs, which are run in the respective components, in the computer apparatus 4. Otherwise, the programs may be stored in a storage medium such as a CD-ROM or distributed over a network, and may thus be installed in the computer apparatus 4 according to a proper timing in order to realize the data processing apparatus.

The processor 41 is an electronic circuit including a controller and calculator of a computer. The processor 41 performs calculation on the basis of data blocks, which are inputted from internal components of the computer apparatus 4, or a program, and outputs a calculated outcome or control signal to each of the components. More particularly, the processor 41 runs an operating system (OS) and application, which are stored in the main memory 42 or auxiliary storage 43, and thus implements the determiner 33 and update device 36.

The term “processor” should be broadly interpreted and shall encompass a central processing unit (CPU) and microprocessor. A digital signal processor, graphics processor, peripheral equipment processor, or any other processor that assists the processor may be included.

The main memory 42 is a memory that tentatively stores an instruction, which is executed by the processor 41, and various data blocks, and may be a volatile memory such as a DRAM or a nonvolatile memory such as an MRAM.

The auxiliary storage 43 is a storage that permanently stores programs and data blocks, and is, for example, a hard disk, storage area network (SAN), optical disk, flash memory, or magnetic tape.

The network interface 44 is an interface through which the computer apparatus is connected onto a communication network wirelessly or by wire. As for the network interface 44, any network interface may be used as long as it conforms to an existing communication standard. The communicator 31 is implemented by the network interface 44.

The device interface 45 is an interface through which the computer apparatus is connected to an external storage medium 5. A standard for connection is not limited to any specific one.

The external storage medium 5 is connected to the computer apparatus 4 through the network interface 44 and device interface 45. The external storage medium 5 may be an appropriate storage medium such as an HDD, CD-R, CD-RW, DVD-RAM, DVD-R, or network attached storage (NAS).

The storage 32 is implemented by the main memory 42, auxiliary storage 43, external storage medium 5, or a combination of these components. For example, the entire storage 32 may be implemented by one or a plurality of main memory 42, auxiliary storage 43, or external storage medium 5. A part of the storage 32 and the other part of the storage 32 may be stored in different places. For example, the measurement data storage 321, data generator 322, and reception power data storage 323 may be implemented by the auxiliary storage 43, and the reference data storage 324 may be implemented by the external storage medium 5. Further, a plurality of storages 32 may exist in the computer apparatus 4. For example, when the storage 32 is implemented in the auxiliary storage 43, data stored in the auxiliary storage 43 is copied into the main memory 42 in order to implement the storage 32 even in the main memory 42.

The input device 46 may include devices for input such as a keyboard, mouse, and touch panel. The feedback device 35 is implemented by the input device 46. A manipulation signal stemming from a manipulation performed on the input device and being sent from the input device 46 is outputted to the processor 41.

The output device 47 may be, for example, a display that displays an image or a device that outputs sounds. For example, a liquid crystal display (LCD), cathode ray tube (CRT), plasma display panel (PDP), or loudspeaker will do. However, the present invention is not limited to these devices. The output device 34 is implemented by the output device 47.

The input device 46 or output device 47 may be connected to the computer apparatus 4 through the network interface 44 or device interface 45.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data processing apparatus comprising:
a reception power data storage configured to store reception power data that contains a plurality of reception power values of a radio signal, which is transmitted from a wireless communication apparatus, obtained by a plurality of measurement apparatuses;
a reference data storage configured to store reference data that is used to determine the state of the wireless communication apparatus; and
a processor configured to determine the state of the wireless communication apparatus which has transmitted the radio signal on the basis of the reception power data and the reference data.

2. The data processing apparatus according to claim 1, wherein what is referred to as the state of the wireless communication apparatus is whether the wireless communication apparatus exists within a predetermined range.

3. The data processing apparatus according to claim 1, further comprising a communicator configured to receive a block of measurement data associated with at least the reception power value of the radio signal, identification information on the radio signal relating to the reception power value, and identification information on the measurement apparatus which has measured the reception power value,
wherein the processor further configured to generate the reception power data from a plurality of the block of the measurement data.

4. The data processing apparatus according to claim 1, wherein:
the reference data is a hyperplane in a multidimensional space; and
the processor determines the state of the wireless communication apparatus on the basis of the hyperplane and coordinates in the multidimensional space represented by the reception power values of the reception power data.

5. The data processing apparatus according to claim 1, wherein:
the reference data is associated with a plurality of data which are the reception power data and the state of the wireless communication apparatus related to the reception power data; and
the processor determines the state of the wireless communication apparatus according to a k-nearest neighbor algorithm.

6. The data processing apparatus according to claim 1, further comprising:
a feedback device configured to acquire the state of the wireless communication apparatus that is associated with the reception power data; and
an update device configured to update the reference data on the basis of the state of the wireless communication apparatus received from the feedback device.

7. The data processing apparatus according to claim 1, further comprising an output device configured to output a result of determination.

8. The data processing apparatus according to claim 7, wherein the output device outputs at least one of image data, text data, audio data, and a lighting control signal.

9. A data processing method executed by a computer, comprising:
storing reception power data that contains a plurality of reception power values of a radio signal, which is transmitted from a wireless communication apparatus, obtained by a plurality of measurement apparatuses;
storing reference data that is used to determine the state of the wireless communication apparatus; and
determining the state of the wireless communication apparatus, which has transmitted the radio signal, on the basis of the reception power data and the reference data.

10. A non-transitory computer readable medium having a computer program stored therein which causes a computer when executed by the computer, to perform processes comprising:
storing reception power data that contains a plurality of reception power values of a radio signal, which is transmitted from a wireless communication apparatus, obtained by a plurality of measurement apparatuses;
storing reference data that is used to determine the state of the wireless communication apparatus; and
determining the state of the wireless communication apparatus, which has transmitted the radio signal, on the basis of the reception power data and the reference data.
